(19) United States
(12) Patent Application Publication
(10) Pub. No.: US 2015/0046740 A1
(43) Pub. Date: Feb. 12, 2015

(54) APPARATUS FOR INDICATING POWER LEVEL OF BATTERY

(71) Applicant: HON HAI PRECISION INDUSTRY CO., LTD., NEW TAIPEI (TW)

(72) Inventor: JEN-JUNG HSIAO, New Taipei (TW)

(73) Assignee: HON HAI PRECISION INDUSTRY CO., LTD., NEW TAIPEI (TW)

(21) Appl. No.: 14/261,557

(22) Filed: Apr. 25, 2014

(30) Foreign Application Priority Data
Aug. 9, 2013 (TW) 102128752

(51) Int. Cl. G06F 1/26

(52) U.S. Cl. CPC G06F 1/26
USPC 713/340

(57) ABSTRACT

An apparatus for indicating power level of battery includes a computer base, a cover pivotally mounted to the computer base, and a battery module mounted to the cover. The battery module includes a battery volume calculating chip and a first battery. The battery volume calculating chip includes a first power level detecting pin. An anode of the first battery is electrically coupled to the first power level detecting pin. A cathode of the first battery is grounded. The battery volume calculating chip detects power level information of the first battery by the first power level detecting pin. The battery volume calculating chip calculates power level of the first battery according to the power level information, and transmits power level of the first battery to the computer base by the data signal output pin. The computer base displays power level of the first battery on the battery module.

### FIELD

The present disclosure relates to an apparatus for indicating power level of a battery in notebook computers.

### BACKGROUND

A conventional notebook computer includes a chargeable battery which is attached to a bottom of the computer. The conventional notebook computer may not be able to indicate a battery level when the computer is shutdown.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded view of an embodiment of an apparatus for indicating a power level of a battery.

FIG. 2 is an assembled view of the apparatus for indicating the power level of the battery of FIG. 1, viewed from one aspect.

FIG. 3 is a circuit view of the battery module of FIG. 1 and FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In the following description the term “coupled” is defined as connected, whether directly or indirectly through intervening components, and is not necessarily limited to physical connections. The connection can be such that the objects are permanently connected or releasably connected.

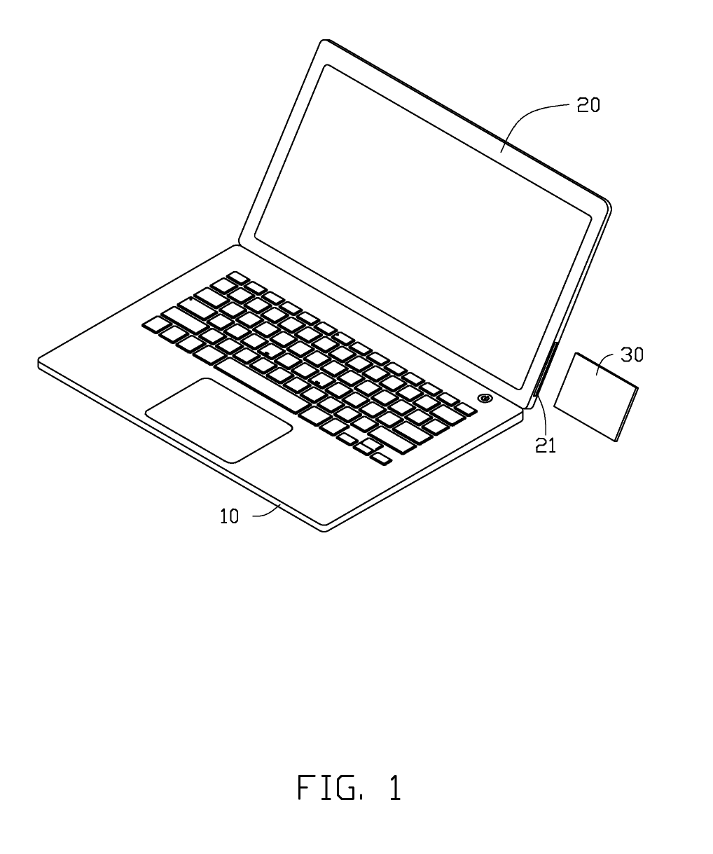

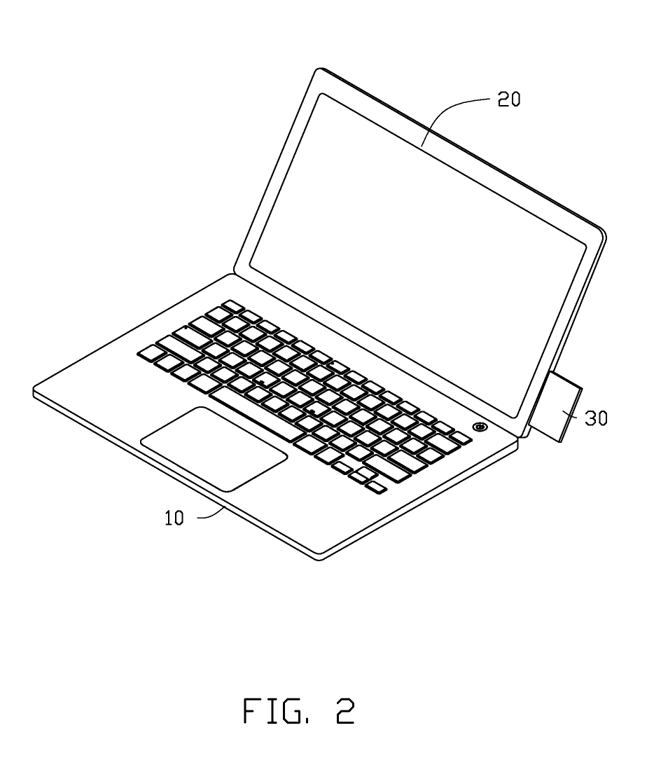

FIGS. 1 and 2 show an apparatus for indicating a power level of a battery of the embodiment. The apparatus includes a computer base 10, a cover 20 pivotally mounted to the computer base 10 and a battery module 30 mounted to one side of the cover 20. A slot 21 is defined in one side of the cover 20. The battery module 30 is inserted in the slot 21 and electrically coupled to the cover 20.

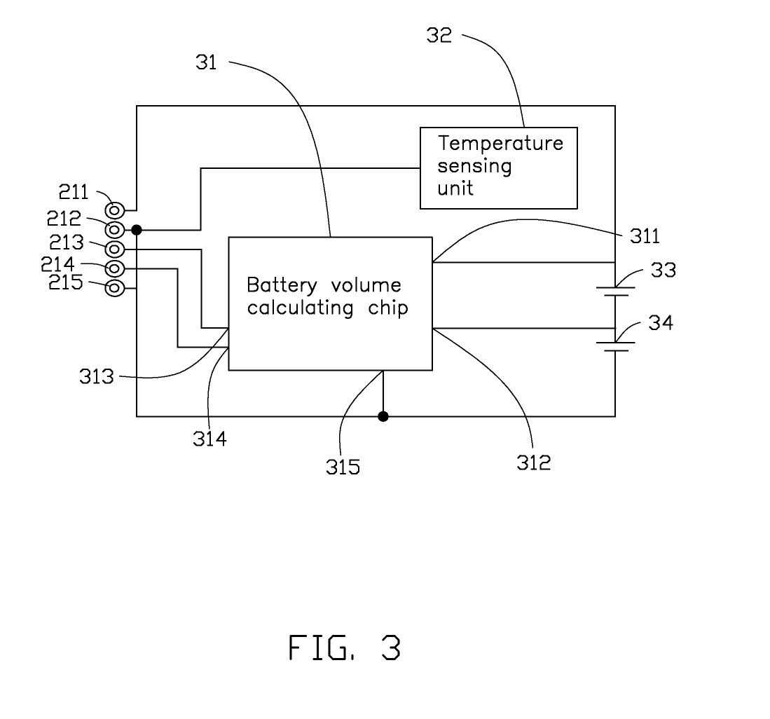

FIG. 3 illustrates the slot 21 includes a battery anode pin 211, a temperature detecting pin 212, a system management data pin 213, a system management clock pin 214, and a first ground pin 215 located therein.

The battery module 30 includes a battery volume calculating chip 31, a temperature sensing unit 32, a first battery 33, and a second battery 34. The battery volume calculating chip 31 includes a first power level detecting pin 311, a second power level detecting pin 312, a data signal output pin 313, a clock signal output pin 314, and a second ground pin 315.

An anode of the first battery 33 is electrically coupled to the battery anode pin 211 and the first power level detecting pin 311 respectively. A cathode of the first battery 33 is electrically coupled to the second power level detecting pin 312 and an anode of the second battery 34 respectively. A cathode of the second battery 34 is electrically coupled to the first ground pin 215 and the second ground pin 315 respectively. The data signal output pin 313 is electrically coupled to the system management data pin 213. The clock signal output pin 314 is electrically coupled to the system management clock pin 214. The temperature detecting pin 212 is electrically coupled to the temperature sensing unit 32 and the first ground pin 215 respectively.

In at least one embodiment, the battery module 30 includes a liquid crystal display (LCD) panel (not shown). The battery volume calculating chip 31, the temperature sensing unit 32, the first battery 33, the second battery 34, and the pins in the slot 21 are interconnected by a number of system management buses (not shown). The temperature sensing unit 32 is located adjacent to the first battery 33 and the second battery 34.

In use, the first power level detecting pin 311 and the second power level detecting pin 312 detects power level information of the first battery 33 and the second battery 34 respectively. The battery volume calculating chip 31 calculates electricity quantities of the first battery 33 and the second battery 34 respectively according to the power level information. The battery volume calculating chip 31 transmits electricity quantities of the first battery 33 and the second battery 34 to the computer base 10 by the data signal output pin 313 and the clock signal output pin 314.

The temperature sensing unit 32 detects temperatures adjacent to the first battery 33 and the second battery 34 respectively. The temperature sensing unit 32 transmits temperatures of the first battery 33 and the second battery 34 to the computer base 10 via the temperature detecting pin 212. The computer base 10 displays electricity quantities and temperatures of the first battery 33 and the second battery 34 on the LCD panel of the battery module 30. The battery module 30 also displays pictures on the LCD panel as an extension display of the cover 20.

Even though numerous characteristics and advantages of the present disclosure have been set forth in the foregoing description, together with details of the structure and function of the disclosure, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. An apparatus for indicating power level of battery, comprising:
a computer base;
a cover pivotally mounted to the computer base; wherein the cover comprises a system management data pin located therein; and
a battery module mounted to the cover; wherein the battery module comprises a battery volume calculating chip and a first battery; the battery volume calculating chip comprises a first power level detecting pin and a data signal output pin; an anode of the first battery is electrically coupled to the first power level detecting pin; a cathode of the first battery is grounded; the data signal output pin is electrically coupled to the system management data pin; the battery volume calculating chip detects power level information of the first battery by the first power level detecting pin; the battery volume calculating chip calculates a power level of the first battery according to the power level information, and transmits the power level of the first battery to the computer base by the data signal output pin; and the computer base displays power level of the first battery on the battery module.

2. The apparatus of claim 1, wherein the cover further comprises a system management clock pin located therein; the battery volume calculating chip further comprises a clock signal output pin; and the clock signal output pin is electrically coupled to the system management clock pin.

3. The apparatus of claim 1, further comprising a slot defined in one side of the cover; and the battery module is inserted in the slot and electrically coupled to the cover.

4. The apparatus of claim 1, wherein the cover further comprises a temperature detecting pin located therein; the battery module further comprises a temperature sensing unit; the temperature detecting pin is electrically coupled to the temperature sensing unit; the temperature sensing unit is located adjacent to the first battery; the temperature sensing unit detects a temperature adjacent to the first battery, and transmits the temperature of the first battery to the computer base; and the computer base displays the temperature of the first battery on the battery module.

5. The apparatus of claim 4, wherein the battery module further comprises a second battery; the battery volume calculating chip further comprises a second power level detecting pin; a cathode of the first battery is electrically coupled to the second power level detecting pin and an anode of the second battery respectively; and a cathode of the second battery is grounded.

6. The apparatus of claim 5, wherein the cover further comprises a battery anode pin and a first ground pin located therein; the battery volume calculating chip further comprises a second ground pin; an anode of the first battery is electrically coupled to the battery anode pin; a cathode of the second battery is electrically coupled to the first ground pin and the second ground pin respectively; and the temperature detecting pin is electrically coupled to the first ground pin.

7. The apparatus of claim 6, wherein the battery anode pin, the temperature detecting pin, the system management data pin, the system management clock pin, and the first ground pin are located in the slot.

8. The apparatus of claim 6, wherein the battery module further comprises a liquid crystal display (LCD) panel; the computer base displays electricity quantities and temperatures of the first battery and the second battery on the LCD panel of the battery module; and the battery module displays pictures on the LCD panel as an extension display of the cover.

9. The apparatus of claim 8, wherein the battery volume calculating chip, the temperature sensing unit, the first battery, the second battery, and the pins in the slot are interconnected by a number of system management buses.

10. An apparatus for indicating power level of battery, comprising:
a computer base;
a cover pivotally mounted to the computer base; and
a battery module mounted to the cover; wherein the battery module comprises a battery volume calculating chip and a first battery; the battery volume calculating chip comprises a first power level detecting pin; an anode of the first battery is electrically coupled to the first power level detecting pin; a cathode of the first battery is grounded; the battery volume calculating chip detects power level information of the first battery by the first power level detecting pin; the battery volume calculating chip calculates power level of the first battery according to the power level information, and transmits power level of the first battery to the computer base by the data signal output pin; and the computer base displays power level of the first battery on the battery module.

11. The apparatus of claim 10, wherein the cover comprises a system management data pin and a system management clock pin located therein; the battery volume calculating chip further comprises a clock signal output pin; the data signal output pin is electrically coupled to the system management data pin; and the clock signal output pin is electrically coupled to the system management clock pin.

12. The apparatus of claim 10, further comprising a slot defined in one side of the cover; and the battery module is inserted in the slot and electrically coupled to the cover.

13. The apparatus of claim 10, wherein the cover further comprises a temperature detecting pin located therein; the battery module further comprises a temperature sensing unit; the temperature detecting pin is electrically coupled to the temperature sensing unit; the temperature sensing unit is located adjacent to the first battery; the temperature sensing unit detects a temperature adjacent to the first battery, and transmits the temperature of the first battery to the computer base; and the computer base displays the temperature of the first battery on the battery module.

14. The apparatus of claim 13, wherein the battery module further comprises a second battery; the battery volume calculating chip further comprises a second power level detecting pin; a cathode of the first battery is electrically coupled to the second power level detecting pin and an anode of the second battery respectively; and a cathode of the second battery is grounded.

15. The apparatus of claim 14, wherein the cover further comprises a battery anode pin and a first ground pin located therein; the battery volume calculating chip further comprises a second ground pin; an anode of the first battery is electrically coupled to the battery anode pin; a cathode of the second battery is electrically coupled to the first ground pin and the second ground pin respectively; and the temperature detecting pin is electrically coupled to the first ground pin.

16. The apparatus of claim 15, wherein the battery anode pin, the temperature detecting pin, the system management data pin, the system management clock pin, and the first ground pin are located in the slot.

17. The apparatus of claim 15, wherein the battery module further comprises a liquid crystal display (LCD) panel; the computer base displays electricity quantities and temperatures of the first battery and the second battery on the LCD panel of the battery module; and the battery module displays pictures on the LCD panel as an extension display of the cover.

18. The apparatus of claim 17, wherein the battery volume calculating chip, the temperature sensing unit, the first battery, the second battery, and the pins in the slot are interconnected by a number of system management buses.
